(19) United States
(12) Patent Application Publication
(10) Pub. No.: US 2006/0191618 A1
(43) Pub. Date: Aug. 31, 2006

(54) Device and process for manufacturing undulating plies

(75) Inventors: Bernard Jault, Aulnat (FR); Michel Filhon, Clermont-Ferrand (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/359,242

(22) Filed: Feb. 22, 2006

(30) Foreign Application Priority Data
Feb. 28, 2005 (FR) 05/01995

(51) Int. Cl. B60C 9/18; B32B 37/00

(52) U.S. Cl. 152/526; 156/199; 156/459; 152/531

(57) ABSTRACT

Process and device intended for the production of an undulating ply (O) formed of a ply of rubber mix reinforced by reinforcement cords (R) arranged side by side in the longitudinal machine direction at a given pitch, in which ply the reinforcement cords (R) form, in the plane of the ply, undulations in the transverse direction of a controlled amplitude and period. This device comprises means for delivering, a continuous straight-cord ply (D), means (1) for undulating the reinforcement cords in the plane of the ply, means (2) for applying retaining cords (B) in the longitudinal direction of the ply.

The invention relates to the field of manufacturing tires, and in particular to the field of manufacturing semi-finished products of the type of reinforcement plies used for example in the crown belts of tires.

Crown belts usually comprise one or more reinforcement belts, composed of cords coated in a rubber mix and forming given angles generally of opposite signs relative to the circumferential direction of the tire.

Furthermore, modern tires nowadays largely use what are called zero-degree reinforcing threads, characterised by the fact that they are formed of reinforcement cords forming a substantially zero angle with the circumferential direction.

The processes for depositing these zero-degree reinforcing threads are themselves widely known. They usually consist of depositing on the shaped tire blank,
either unit threads coated with rubber product or strips of low width, formed of a small number of unit threads, by winding successive turns over the width of the crown,
or one to two turns of a section of ply made of semi-finished product itself formed of cords oriented at zero degrees and the width of which corresponds substantially to the width of the crown of the tire.

Here “strip” or “ply” is understood to mean a continuous strip or a straight-cord ply made from a rubber mix and reinforced by one or more cords arranged side by side, parallel to each other and extending in the longitudinal direction of the strip. A “cord” may refer to a unitary cord, a cabled yarn composed of several unit threads, or alternatively a plied yarn, and it may be textile or metallic in nature.

However, with the aim of solving the problems linked to the variations in circumference of the tire blank between the step of laying the zero-degree reinforcing threads and the final step of shaping in a curing press, it was proposed to lay the cords or strips of cords by forming slight undulations. This technique has the advantage of being able to adapt the length of cords laid to the final circumference of the tire.

In this respect, the technique of laying by winding turns of cords or of strips of low width proves particularly suitable, in particular for laying cords of low elasticity, such as metal wires, for example. These techniques are described by way of illustration in EP 1 208 963. They are characterised by laying the cord or strip directly on the tire blank.

The process of producing continuous strips or plies reinforced by cords which undulate in the plane of the ply, which plies are commonly referred to by the name “undulating ply”, is distinguished from the above techniques in that this process comprises two stages. In a first step, in a dedicated process, undulating plies in the form of continuous strips of great lengths are produced. Then in a second step the ply is cut into sections of a given length, and said sections are wound on to the tire blank.

The processes for producing undulating plies the reinforcement cords of which have undulations in the transverse direction of the plane of the ply are known and are described by way of example in document EP 724 949. They consist of supplying the reinforcement cords at a given speed and, using a given means, displacing the reinforcement cords transversely to the machine direction so as to create an undulation of the reinforcement cords, and to deposit these cords on a support which may be a strip or a ply of rubber or of plastics material. The speed of the support is adapted to receive the cords.

It is also possible to deposit a second layer of support material to ensure that the cords thus sandwiched between two strips of rubber or plastics material are held properly in position. The rubber plies also have the function, as will be seen hereafter, of providing the undulating ply thus obtained with a certain longitudinal tensile strength so as to permit manipulation of the ply in the subsequent assembly operations, without adversely affecting the geometric characteristics of the undulations imparted to the reinforcement cords.

The ply of finished product thus obtained may be cut into one or more sections of given length which can be wound on to a tire blank in a first diameter. Upon the shaping in the press, the reinforcement cords are brought to a second diameter, greater than the previous one, and then lose their undulations and adopt a substantially rectilinear direction forming an angle equal to zero degrees with the longitudinal direction.

This embodiment yields good results, but requires rigorous control of the depositing of the cords to prevent them becoming superposed on one another, in particular when there is a large number of cords to be deposited on strips of great width, which involves considerable and hence costly dedicated means.

This is why attempts have been made to find an embodiment which is more flexible and less demanding in terms of capital investment, while having available a semi-finished product capable of being used without deformation on conventional assembly means.

The continuous production of straight-cord plies is widely known. The traditional manufacturing means consist of a set of calenders for coating a ply of reinforcement cords arranged side by side, and parallel to one another in the longitudinal direction, with a rubber mix. The semi-finished product thus formed is in the form of a continuous strip, commonly known as a straight-cord ply, in which the reinforcement cords are covered by a controlled thickness of mix, and in which the spaces between the cords are filled with said mix. Plies of this type are manufactured industrially at relatively low cost.

The problem which the invention solves is to propose a device and a process which make it possible to produce a continuous undulating ply from a straight-cord ply produced on a traditional means.

The device according to the invention comprises:
means for delivering, at a given controlled speed V1, a continuous straight-cord ply composed of a ply of rubber mix reinforced by cords arranged side by side and parallel to one another in the longitudinal direction at a given pitch,
means for displacing the whole of said straight-cord ply in alternating manner transversely to the machine direction and in the plane of the ply,
receiving means arranged downstream of the transverse displacement means and cooperating with the latter, having a linear speed V2 less than V1,
means for applying retaining cords arranged on the downstream part of the receiving means,
means for laying or conditioning the undulating ply.

The means for displacing in alternating manner transversely to the machine direction and in the plane of the ply have the technical effect of imparting an undulating form to the entire ply and cords forming it, when said ply is deposited on an axially fixed receiving means.

The linear speed in the longitudinal direction of the receiving means (V2) is adjusted relative to the delivery speed of the straight-cord ply to the entrance to the device such that the ratio of the speeds V1/V2 corresponds to the ratio of a length of undulating cord between two given points and the length of the chord joining these two points.

An other process consist in passing the ply between a pair of gear-shaped roller in meshing engagement to undulate the ply in a direction perpendicular to the plane of the ply and passing the shaped ply between a pair of rolls to lay down the undulated ply into a planar arrangement as described in patent EP 431 187.

However, even though the semi-finished product thus obtained does indeed have the required undulating form, it will be observed that it is unusable as-is on conventional manufacturing means owing to the total absence of longitudinal tensile strength once detached from the receiving means. The ply tends to readopt the form of a straight-cord ply.

This phenomenon is accentuated further when straight-cord plies containing metal reinforcement wires are used. The latter, after having been formed into an undulating shape, act as springs and develop elastic forces the resultant of which is a longitudinal force, the effect of which is to detach the ply from the support and to cause kinking, making it unsuitable for use.

This problem is solved by depositing rectilinear retaining cords on at least one of the faces of the undulating ply in the longitudinal direction. The retaining cords are arranged transversely at a given pitch greater than the pitch of the reinforcement cords. Surprisingly, the undulating ply obtained does not kink and retains its geometry, even in the case of metal reinforcement wires of great stiffness, subject to adapting the laying pitch of the retaining cords.

Thus, by judicious selection of the pitch and the strength of the retaining cords, it is possible to impart to the semi-finished product sufficient tensile strength to make it capable of being satisfactorily used on conventional manufacturing means, and in particular to make it capable of being subjected to the longitudinal forces linked to the laying tensions imparted to the product during the assembly operation.

A laying pitch for the retaining cords of between 10 and 50 mm makes it possible to fit the majority of configurations tested. Selecting a lesser pitch is recommended for the metal reinforcement wires of great stiffness such as mentioned above; a laxer pitch can be adopted for plies comprising textile reinforcement cords.

To make this undulating ply usable in a tire, it is also advisable to ensure that the undulating ply, as defined above, once integrated into the construction of a tire blank, can undergo the final shaping such that the reinforcement cords form a substantially zero angle with the longitudinal direction. To this end, it is advisable to select the nature of the retaining cord judiciously.

A first possibility consists of selecting an elastic retaining cord. By suitably adapting the laying pitch of the retaining cords and the elasticity of each of said retaining cords, an attempt will be made on one hand to stabilise the undulating ply in the longitudinal direction when the latter is detached from the receiving means or the conditioning means, and on the other hand to ensure that, during the shaping, the additional force for elongating the retaining cords until the reinforcement cords are aligned with the longitudinal direction is negligible. Consequently, the elasticity of the retaining cords must be neither too great nor too low.

In practice, an undulating fabric having undulations of a period equal to 115 mm with an amplitude of 8 mm was satisfactorily produced from a straight-cord ply composed of cabled metal reinforcement wires of type 2/23 arranged with a density of 143 wires per dm, using elastic retaining cords having an elongation of approximately 5% at 5 daN at a pitch of 30 mm. The pitch of the retaining cords was reduced to 25 mm when the metal wire was replaced by a cabled metal wire of type 19/18.

A second possibility consists of using a retaining cord having low elasticity but having a low tensile strength. Under these conditions during the shaping in the press the retaining cords break, enabling the reinforcement cords to align themselves with the longitudinal direction.

In practice the brittle retaining cords have a tensile strength of between 2 and 10 daN.

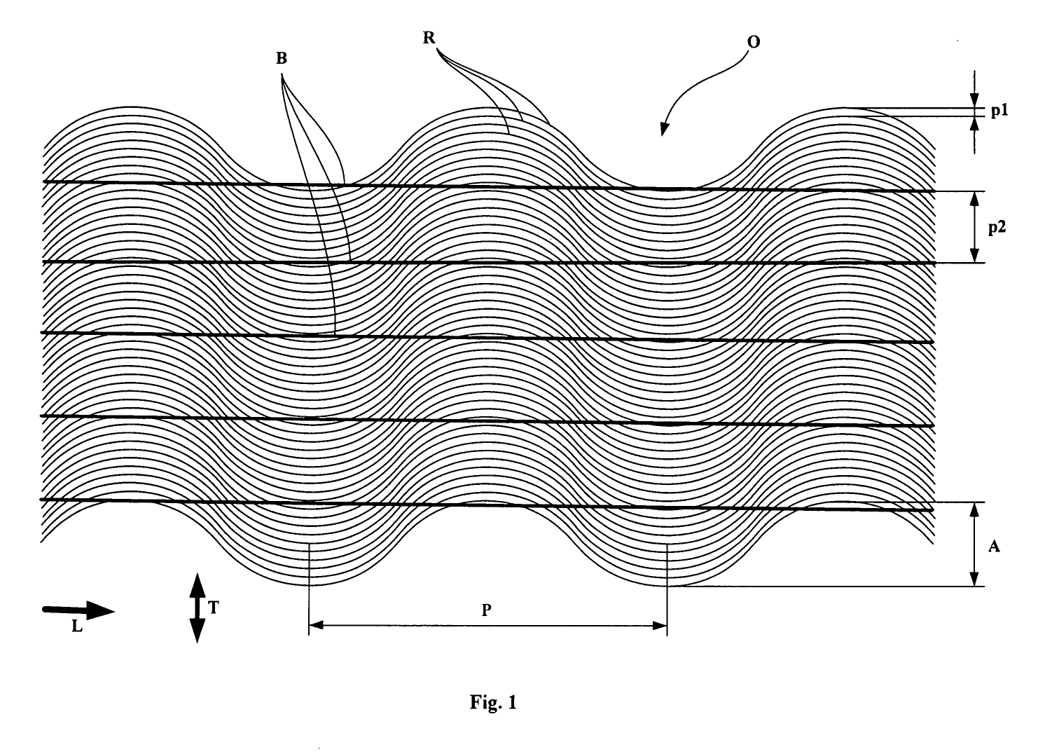

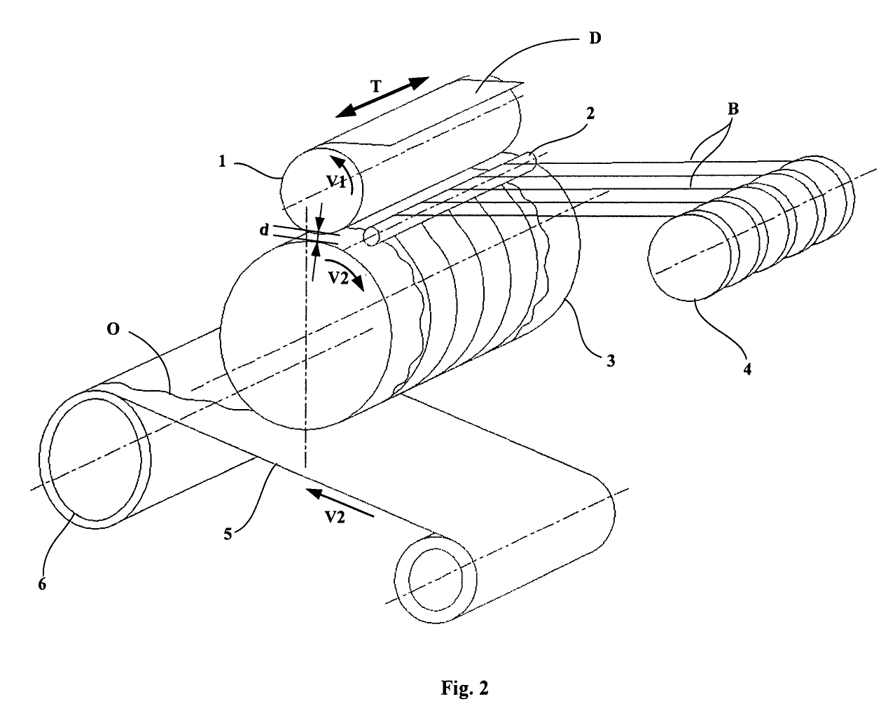

A device according to the invention is described hereafter with reference to the appended figures, in which:
FIG. 1 is a diagrammatic view of a section of undulating ply,
FIG. 2 is a diagrammatic view of a device according to the invention.

FIG. 1 is a diagrammatic plan view of a section of undulating ply O in which there can be seen the reinforcement cords R arranged side by side in the longitudinal direction L at a given pitch p1, in which the cords form undulations in the transverse direction T of an amplitude A and of a period P in the plane of the ply O. The retaining cords B are arranged in rectilinear manner in the longitudinal direction L on one face of the ply O. They are spaced apart by a pitch p2 greater than the pitch p1 of the reinforcement cords.

FIG. 2 is a diagrammatic perspective view of a device capable of producing undulating fabrics according to the invention.

This device comprises means for delivering a continuous straight-cord ply D at a controlled speed V1. These means are not shown in FIG. 2 but are formed of conventional means for feeding and unwinding a continuous strip of flat product arranged on a protective backing. The straight-cord ply D is composed of reinforcement cords arranged side by side and parallel to one another in the longitudinal direction at a given pitch. The pitch of the reinforcement cords is substantially equal to the pitch p1.

The ply is wound onto a first roller 1, referred to as undulation roller, which is moved in a transverse alternating movement in the direction T, parallel to the axis of rotation of the roller. The speed of rotation of the undulation roller 1 is adjusted such that its circumferential speed is equal to V1.

A second roller 3, referred to as receiving roller, is arranged downstream of the undulation roller. The receiving roller 3 onto which the ply is also wound on emerging from the undulation roller has its speed of rotation adjusted such that its circumferential speed V2 is less than V1.

The distance d between the circumference of the undulation roller and the circumference of the receiving roller is adjustable.

By displacing the undulation roller 1 in alternating manner in the transverse direction T with a given period and frequency, an undulation of all the reinforcement cords R of the ply O in the plane of said ply is created when the latter is deposited on the receiving roller 3.

The period and the amplitude of the transverse movement of the undulation roller 1, the distance d, and the speeds V1 and V2 are adjusted in known manner in order to obtain a period P and an amplitude A of the undulation of the reinforcement cords R, once the latter have been deposited on the receiving roller 3.

It is nevertheless observed, experimentally, that the forces linked to the thrust of the whole of the ply in the transverse direction tend to cause said ply to slip on the undulation and receiving rollers. It is therefore important for the receiving roller and the undulation roller to be designed to permit high transverse forces.

The effect of the slipping in the transverse direction is to destroy the geometric regularity of the undulations. It can be overcome by treating the surface of the rollers so as to improve the adherence of the ply to said rollers.

To this end, a first solution consists of imparting magnetic properties to the surface of said rollers. This solution is obviously viable only in the event that the ply is formed of metal reinforcement wires.

Another solution consists of varying the surface temperature of the rollers.

It is also possible to adjust the tension between the feed and unwinding system of the straight-cord ply and the undulation roller. However, it will be observed that the tension between the undulation roller and the receiving roller must be adjusted to values which are as low as possible in order to enable the ply to be deposited without longitudinal deformation on the receiving roller.

The means for applying the retaining cords (2, 4) are formed of an unreeling means 4 and an application roller 2 which is arranged on the downstream part of the receiving means. The retaining cords B are deposited in rectilinear manner on at least one of the faces of the undulating ply O so as to prevent any longitudinal deformation of said ply when the latter is detached from the receiving roller or its conditioning support.

The conditioning means are formed by a backing 5, travelling at the speed V2, on which the undulating ply O is deposited. The undulating ply O and the backing 5 are wound jointly about a motor-driven shaft 6.

It is possible to produce equivalent devices using conveyor belts instead of the rollers; in that case it will be necessary to ensure that the mobile parts are capable of withstanding the transverse forces linked to the movements of the ply under the effect of the undulation.

It is also possible to conceive of the undulating strip being deposited on a transfer means linked to the cylindrical surface of an assembly drum intended for producing a tire or directly on the surface of an assembly drum. This arrangement makes it possible to dispense with the conditioning and storage operation, and may prove of interest when the consumption of undulating ply at the entry to the assembly machine is high.

The process for manufacturing an undulating ply (O) from a straight-cord ply using the device described above comprises the following steps:
producing a continuous strip of continuous straight-cord ply (D) composed of a ply of rubber mix reinforced by reinforcement cords (R) arranged side by side and parallel to one another in the longitudinal direction (L) at a given pitch (p1), using a traditional process,
delivering said straight-cord ply (D) at a controlled linear speed V1,
displacing in alternating manner the whole of said ply transversely to the machine direction in the plane of the ply,
applying the undulating ply (O) thus formed to a receiving means (3) having a linear speed V2 less than V1,
depositing on at least one of the faces of the undulating ply (O), in the longitudinal machine direction, rectilinear retaining cords (B) by arranging them transversely at a given pitch (p2),
depositing the undulating ply (O) on a transfer or conditioning means (5, 6).

These process steps can easily be integrated into the general process of manufacturing a tire either at a centralised means which distributes the finished products over the entire tire assembly means, or directly at an assembly machine owing to its great simplicity of use and flexibility of use.

Furthermore, although the use of undulating plies has become widespread for the production of the crown reinforcement plies of tires, the process and the device described above can be adapted perfectly well for the production of undulating plies located in other parts of the tire.

1. A process for manufacturing a tire comprising an undulating ply (O) consisting of a ply of rubber mix reinforced by reinforcement cords (R) arranged side by side in the longitudinal machine direction (L) at a given pitch (p1), and in which the reinforcement cords (R) form, in the plane of the ply, undulations in the transverse direction of an amplitude (A) and a period (P), which process is characterised in that it comprises the following steps:
producing a continuous strip of continuous straight-cord ply (D) composed of a ply of rubber mix reinforced by reinforcement cords (R) arranged side by side and parallel to one another in the longitudinal direction (L) at a given pitch (p1), using a traditional process,
displacing alternatively the whole of said ply to create, transversely to the direction of the ply, undulations of the reinforcement cords in the plane of the ply,
depositing on at least one of the faces of the undulating ply (O), in the longitudinal direction, rectilinear retaining cords (B) by arranging them transversely at a given pitch (p2).

2. A device intended for the production of an undulating ply (O) formed of a ply of rubber mix reinforced by reinforcement cords (R) arranged side by side in the longitudinal machine direction (L) at a given pitch (p1), in which ply the reinforcement cords (R) form, in the plane of the ply, undulations in the transverse direction of a controlled amplitude (A) and period (P), which device is characterised in that it comprises:
means for delivering a continuous straight-cord ply (D) composed of a ply of rubber mix reinforced by reinforcement cords (R) arranged side by side and parallel to one another in the longitudinal direction (L) at a given pitch (p1),
transverse displacement means for delivering an undulated ply by displacing alternatively the whole of said ply, to create transversely to the direction (L) of the ply, undulations of the reinforcement cords in the plane of the ply,
receiving means (3) arranged downstream of the transverse displacement means (1) and cooperating with the latter,
means (2), arranged on the downstream part of the receiving means (3), for applying retaining cords (B) in the longitudinal direction (L).

3. A device according to claim 2, in which the means for transversely displacing the straight-cord ply (D) comprise an undulation roller (1) around which said straight-cord ply (D) is wound, said undulation roller being moved at a circumferential speed V1 and an alternating transverse movement of given period and amplitude.

4. A device according to claim 2, in which the receiving means are formed by a receiving roller (3) moved at a circumferential speed V2 and around which the undulating ply (O) is wound.

5. A device according to claim 3, in which the distance (d) between the circumference of the undulation roller (1) and the circumference of the receiving roller (3) is adjustable.

6. A device according to claim 2, in which the surfaces of said undulation (1) and receiving (3) rollers have properties which enable them to increase the adherence of the plies (D, O) travelling over their respective circumferences.

7. A device according to claim 6, in which the surfaces of the undulation (1) and receiving (3) rollers have magnetic properties.

8. A device according to claim 6, in which the surfaces of the undulation (1) and receiving (3) rollers are thermally controlled.

9. A device according to claim 2, in which the transverse displacement means comprise a pair of gear-shaped roller in meshing engagement to undulate the ply in a direction perpendicular to the plane of the ply and rolls to lay down the undulated ply into a planar arrangement.

10. A tire produced from an undulating ply (O), composed of a ply of rubber mix reinforced by reinforcement cords (R) arranged side by side in the longitudinal direction (L) at a given pitch (p1), in which ply said reinforcement cords form, in the plane of the ply, undulations in the transverse direction of a controlled amplitude (A) and period (P), characterised in that rectilinear retaining cords (B) are placed on at least one of the faces of the undulating ply (O) in the longitudinal direction (L) and are arranged transversely at a given pitch (p2) greater than the pitch (p1) of the reinforcement cords (R).

11. A tire according to claim 10, in which the retaining cords (B) of the undulating ply (O) are elastic and have a resistance to elongation of approximately 5 daN at 5% elongation.

12. A tire according to claim 10, in which the retaining cords (B) of the undulating ply (O) are slightly elastic and have a tensile strength of between 2 daN and 10 daN.

13. A tire according to claim 10, in which the retaining cords (B) of the undulating ply (O) are arranged transversely at a pitch (p2) of between 10 and 50 mm.
